(19) United States
(12) Patent Application Publication
(10) Pub. No.: US 2014/0278561 A1
(43) Pub. Date: Sep. 18, 2014

(54) COMPUTERIZED SYSTEM AND METHOD FOR DETERMINING FLOOD RISK

(71) Applicant: Stoneriver National Flood Services, Inc., Kalispell, MT (US)

(72) Inventor: Greg Knuffke, Kalispell, MT (US)

(73) Assignee: Stoneriver National Flood Services, Inc., Kalispell, MT (US)

(21) Appl. No.: 13/804,505

(22) Filed: Mar. 14, 2013

(51) Int. Cl. G06Q 40/08

(52) U.S. Cl. CPC G06Q 40/08
USPC 705/4

(57) ABSTRACT

The present invention is a system for communicating the flood risk of a property to a user comprising a computer network, a first computerized device for displaying flood risk information in electronic communication with a computer network, a first database connected to said network, where said first database contains flood zone information arranged by geographic coordinates, a second database connected to said network, where said second database contains terrain elevation data arranged by geographic coordinates, a third database connected to said network, where said third database contains rainfall data arranged by geographic coordinates, a fourth database connected to said network, where said fourth database contains a record of prior flooding arranged by geographic coordinates, a fifth database connected to said network, where said fifth database contains a record of losses arranged by geographic coordinates, and a second computerized device connected to said network which calculates flood risk information for geographic location using an algorithm to process database information contained in said databases.

### BACKGROUND AND SUMMARY OF THE INVENTION

Exemplary embodiments of the present invention relate generally to a predictive model for determining insurance risk and, more specifically, flood insurance risk.

Flooding is the most common natural disaster in the United States. It has been calculated that in high risk areas, flooding is more than twice as likely to damage a structure than fire. Floods may be the result of a storm or hurricane, heavy rains, flash floods, ice jams, levees, snowmelt, spring thaw, and new development which changes the natural runoff paths present on the land. Flooding and flash floods can occur in all fifty states.

Significant property damage or loss of possessions may result from such flooding. For example, according to the Federal Emergency Management Agency (“FEMA”), flood losses for US states and territories from Jan. 1, 1978 to Nov. 30, 2012 have been calculated by FEMA to be over $42 trillion. From 2002 to 2011, flood insurance claims averaged over $2.9 billion per year. Just one inch of flood water can cause $20,000 damage to an average home. Generally, basic homeowner's insurance does not cover flood damage, leaving many homeowners exposed to liability for expensive property damage caused by flooding. Owners and lessees of real property may purchase flood insurance as additional coverage, paying a policy premium based on a flood zone risk area in which the real property is located.

Currently, in order to calculate flood risk assessment for any given location, a flood insurance provider uses a property's geographic location to determine the property's flood risk using FEMA's Flood Insurance Rate Maps (“FIRM”s). FIRMs include historical and statistical information such as topographic surveys, rainfall amount, river flow, storm ties and hydraulic analysis. These maps experience periodic changes due to community development, weakening flood control measures, changes in topography and technological improvements. Even with periodic updates, many regions are out of date in regards to its flood risk.

FIRMs categorized the landscape into risk zones. High risk zones may comprise Special Flood Hazard Areas (SFHA) and moderate-to-low risk areas are classified as Non-Special Flood Hazard Area (NSFHA). SFHAs are commonly flood plains associated with bodies of water, such as rivers and streams, and are defined formally as having a 1-percent annual change of being flooded. These 1-percent zones are also commonly referred to as 100 year flood zones. SFHAs include several sub-categories of flood zone areas including coastal zones which are assigned to the “V” subcategory of SFHAs. NSFHAs are areas that are in moderate-to-low flood risk zones and are not in immediate danger from flooding caused by overflowing rivers or hard rains. NSFHAs are defined as having a 0.2-percent annual chance of flooding. These 0.2-percent zones are also referred to as 500 year flood zones. NSFHAs are further separated into B, C, and X sub-zones. NSFHA locations may be outside high risk areas but are still prone to flooding as evidenced by their making up over 20% of insurance claims and one-third of disaster assistance requests due to flooding. Some geographic locations have been left undetermined by the FIRM system. A significant shortcoming of FIRMS and other existing flood risk data is that it is difficult to understand for the average layperson. A FIRM may illustrate geographic references related to water such as streams, lakes, and rivers. Each of these water references may have flood plains and other flood zones associated with them which are illustrated on the FIRM as shaded areas, often having large numbers of reference lines and different types of shading. In looking at such a representation, an uninformed viewer may not understand what is being viewed and incorrectly assume that his or her real property is not at risk, or conversely, at such great risk that flood insurance would be prohibitively expensive to obtain.

A typical process for determining the flood risk for a parcel of real property often involves a potential customer contacting an insurance provider to request flood insurance. The customer may be asked to provide an address for the real property. The provided address may be used by the insurance provider to determine location of the parcel on a FIRM. The risk category of the parcel is obtained from the FIRM and the decision to underwrite flood insurance may be determined based on that category. This process requires an understanding of flood risk ratings and how to apply those ratings to a piece of real property in order to estimate the risk of property damage due to flooding.

Current flood risk maps are relatively granular in nature and there remains a need for more accurate models to predict payment costs to flood insurance policy holders made available to insurance underwriters. Underwriting an insurance policy solely based on flood risk maps cannot discriminate between individual properties or micro locations within a flood maps grid. Using the FIRM system to determine insurable risk results in what may be paraphrased as a “yes”, “no”, or “maybe” result. A “yes” result may be used to establish an acceptable risk and may result in the issuance of an insurance policy to the property owner. A “no” or “maybe” result creates more of a problem for insurers. Both results may require a more detailed investigation or result in a sometimes unnecessary refusal to underwrite coverage. When such a refusal is not based on a definitive risk but instead on a lack of the ability to calculate a risk, an insurance provider may be missing an opportunity to underwrite a policy that would be a favorable risk had the insurance provider been able to more accurately determine the property loss risks associated with flooding. What is needed is a computerized method for estimating a flood insurance policy cost by adding to traditional flood maps, a plurality of informative data.

A homeowner or lessee may wish to learn about the possible flood risk to a property currently owned or leased or may be researching a property under consideration. To obtain data from an embodiment of the invention, an address may be submitted, using a web page or other user interface, for which flood risk information is desired. The submitted address may be used to determine a location on a map at which a property is located. A portion of such a map which contains the submitted address may be retrieved from a database and stored in the memory of a computing device for later display on a web page, creation of a printed report, or to be used for other suitable means of communicating flood risk data. Once a map area has been identified, additional information may be retrieved from electronic databases for the portion of the map displayed. Such information retrieved may comprise flood zone risk data available from the Federal Emergency Management Agency (FEMA) or other sources, storm water runoff maps and calculators, and elevation data. Elevation data may be from sources such as geographic information systems (GIS), topographic maps and databases, and light detection and ranging (LIDAR) mapping techniques. LIDAR may be used to create digital terrain and digital elevation models. These models may be used to accurately map terrain topologies and structure heights to identify low points on a structure's foundation.

Using these sources, geographic elevation data for various points on the area represented by the map may be obtained or calculated. Such sources may also be used to gather data points that correspond to distances between various geographic points on a flood risk map. Additional non-map based sources may contain rainfall history, other historical water accumulation data, and flood insurance claims data. These data sources may be used to calculate a flood risk for a geographic area.

To shorten the time required to retrieve and calculate risks based on such data, the data may be retrieved in advance and the risk calculated for areas for which no address information has been entered. Such calculated risks may be stored in a database which corresponds to a map or grid arrangement of geographic locations for more rapid recall and display.

Another embodiment of the current invention may be implemented using a web interface in which a property address is entered to reveal a graphical representation of a geographic map which includes the entered address and an area surrounding the address. The map may display flood risks using color coding to display greater and lesser areas of risk. Such a method of color coded display is commonly called a “heat map.” Such a web interface may comprise additional risk information such as a calculated risk score or rating for the address entered. The score may be displayed as a discrete score; an indicator positioned on a low to high scale; or may be displayed as a relative score such as low, medium, high.

Still another embodiment of the current invention may be an interface intended to be used by more knowledgeable users such as insurance brokers or other commercial concerns. Such an interface, in addition to displaying risk map information as previously described, may also be configured to provide discrete risk score information to assist in the identification of potential customers in a geographic area served by the commercial user. Such scores may also be used to preliminarily determine eligibility and estimated cost for flood risk insurance for identified properties. In another embodiment of the present invention, it may be used to set flood insurance premiums. Such an embodiment may allow for the entry of additional information regarding the real property and structures located thereon. Information such as construction details and methods, landscaping, other property improvements and modification, and flood protection improvements, may be entered using a user interface. Once entered, such factors may be used to adjust the calculated risk to more accurately reflect the actual risk faced by the identified property.

In addition to the novel features and advantages mentioned above, other benefits will be readily apparent from the following descriptions of the drawings and exemplary embodiments.

### BRIEF DESCRIPTION OF THE DRAWINGS

FIG. 1 is a diagram of a computer network used in an exemplary embodiment of the present invention;

FIG. 2 is a diagram of an exemplary embodiment of a computing device used to execute a risk calculation algorithm;

FIG. 3 is a first screenshot of a screen shot displayed by an exemplary embodiment of the present invention;

FIG. 4 is a second screenshot of a screen shot displayed by an exemplary embodiment of the present invention;

FIG. 5 is a flowchart of a user interaction with a user interface of an embodiment of the present invention;

FIGS. 6a & 6b are a flowchart of the risk calculation algorithm of an exemplary embodiment of the present invention;

FIG. 7 is a perspective view illustration of a body of water and two exemplary flood risk zones;

FIG. 8 is a side view representation of a body of water, flood risk zones, and a structure;

FIG. 9 is an illustration showing an aerial view of flood zones, water control structures, and a building;

FIG. 10 is a chart showing an example of a combined risk score for flood variables of the present invention.

### DETAILED DESCRIPTION OF EXEMPLARY EMBODIMENT(S)

The disclosed methods may be implemented as computer-executable instructions stored on one or more computer-readable storage media and executed on a computing device. Such devices may include, but are not specifically limited to, commercially available computers, including tablet computers and smart phones or other mobile devices that include computing hardware. The computer-executable instructions for implementing the disclosed techniques as well as any data created and used during implementation of the disclosed embodiments may be stored in one or more computer-readable media. Such instructions can be executed on a single local computer or in a networked computer environment, including a cloud computing network, using one or more network computers.

As is well known in the art, any of the software-based embodiments may be uploaded, downloaded, or remotely accessed through a suitable communications means. Such suitable communications means may include, for example, the internet, the World Wide Web, an intranet, software applications, cable (including fiber optic cable), magnetic communications, electromagnetic communications (including RF, microwave, and infrared communications), electronic communications, or other such communications means.

Although the operations of some of the disclosed methods are described in a particular, sequential order for convenient presentation, it should be understood that this manner of description encompasses rearrangement, unless a particular ordering is required by specific language set forth herein.

Referring to FIG. 1, in an exemplary embodiment of the invention, a computing device 100, may be connected to the internet 102. Also connected to the internet may be a webpage server 104. Databases may be connected to a network which is connected to the webpage server 104. Such databases may comprise flood risk information databases 106 provided by FEMA or other information providers, databases of rainfall accumulation, levee and dam locations and characteristics 108, historical flood data 110, and flood insurance claim data 112. To obtain flood risk information, a user may cause the computing device 100 to connect to the web page server which provides a flood risk user interface as illustrated in FIG. 3. A second computing device 114 may be used to calculate risk variables using the flood risk algorithm described herein and information from at least one of the previously described databases for display a the flood risk user interface.

Referring to FIG. 2, a diagram of an exemplary computing device 114 is shown. Such a device may comprise a processor 200, information storage 202, program memory 204, a data bus 206, an operating system 208 which may be used to manage the various components of the computing device, and network interface components 208 used to connect the computing device to at least one computer network. The computing device may also comprise computer programs 212, which may execute the algorithms described herein. The computing device may also comprise optional components including user input devices 214 and 216, video adapter circuitry 218, an optical or floppy disk drive device 220 and a display device 222.

As illustrated in FIG. 3, in an exemplary embodiment of the invention, a user interface 300 may be presented to a user. The user may enter an address for which risk information is sought into a data entry field 302 of the user interface. Upon entry of an address, the user interface may display a map containing the address entered 304, such a map may also display bodies of water 306 or areas prone to flooding 308. The flood risk areas present on the displayed map area may be shaded in color 310 to designate the severity of flood risk present in a given area. Presenting flood risk as shaded areas may allow a viewer to quickly determine the different areas of flood risk present. As is illustrated in FIG. 4, an area 400 close to a body of water prone to flooding may be a higher flood risk than a second area 402 that is located a distance away from a body of water.

FIG. 5 shows an exemplary flow chart 500 of the steps which may occur as a user enters an address to view flood risk results in a web page format. In step 502, a user may direct a web browser to display a flood risk website. In step 504, the flood risk website prompts the user to enter an address or other location information to identify a geographic area for which flood risk information is desired and the user enters an address or other information corresponding to a geographic area. In step 506, the entered information is used to determine the correct geographic area to display to the user. In step 508, a web server prompts the user to select risk information to be displayed and then provides that information from a flood risk database for display in the user's instance of the flood risk web page. The flood risk database may have been calculated prior to a user entering an address in the user's web browser for display.

Flood risk may be calculated using basic flood risk data provided by FEMA or other risk calculation providers. FIGS. 6a-6b show an exemplary flow chart 600 of a computerized process to calculate flood risk for an address or geographic location. Such a process may be executed by a computer algorithm “on demand”, such as when a user enters and address, or the process may be executed in advance of address entry to create a database of flood risks associated with geographic areas. Such an executed in advance process may allow for a faster response to user requests.

Referring to FIGS. 6a-6b, in step 602, an entered address is used to locate a geographic location. The steps that follow describe retrieving data for a specific location but one skilled in the art will understand that these steps may be repeated for areas adjacent to such a specific location to produce a group of risk values for display on a risk map. In step 604, a flood risk value is retrieved from a flood risk database. In step 606, one or more databases containing elevations and geographic distances may be referenced to determine distances and elevations between the entered address and sources of flood risk. In step 608, such distance and elevation information may be used to calculate a combined elevation and distance primary risk value. In step 610, one or more databases containing secondary risk information are referenced. Such secondary risk information databases may contain rainfall accumulation data for a geographic location. Such accumulation data may comprise expected water that may accumulate as the result of surface water runoff from areas of higher elevation that may surround such a geographic location. Certain areas may be more susceptible to accumulation resulting from surface water runoff. Examples may include depressions in the earth, gullies, creeks, streams, rivers, and other such geographic features. Secondary databases may also contain information regarding flood control infrastructures such as dams and levees and historical flooding data. In step 612, secondary risk values may be factored and scaled to determine secondary risk score. In step 614, one or more databases containing tertiary risk information may be referenced. Tertiary risk databases may contain data representing preferred risk policy repetitive flooding losses and losses for non-special flood risk areas. Such tertiary losses may be calculated for a geographic region rather than a specific address. United States Postal Service Zip+4 codes may be used to identify such a geographic region. In step 616, tertiary values may be factored and scaled to determine a tertiary risk score. In Step 618, primary, secondary, and tertiary factors may be combined to produce a combined risk score. Such a combined risk score may be used to produce a color coded risk map as described above or may be used to estimate losses based upon historical loss data for similar risk ratings. A chart showing an exemplary implementation of the combined risk score is shown at FIG. 10. As is illustrated in the chart of FIG. 10, primary factors are multiplied by a first weight factor 1002, secondary risk factors are multiplied by a second weight factor 1004, and tertiary factors are multiplied by a third weight factor 1006. The numerical values illustrated in FIG. 10 are exemplary and may be adjusted as desired to improve the accuracy of the resultant combined risk score.

Primary Risk Value Calculations

A primary risk value or factor may calculated using distance and elevation change from a flood risk zone. Referring to FIG. 7, a flood risk zone associated with a stream 700, is shown as a broken line at 702. A second zone, associated with a flood risk that is ½ of the flood risk zone is shown as a pair of dashed lines 704. Stated another way, the risk of flooding is half as great for a point located on the dashed lines 704 as it would be for a point located on the broken line 702. Referring to FIG. 8, primary risk values are calculated using the change in elevation 800 between a flood zone 702, and a risk location 802. The elevation 804 between a ½ flood risk zone 704 and the structure 802 may be also used to calculate primary risk elevation values. Primary risk values may also be calculated based on the distance 806 from the flood risk 702 and risk location 802 and the distance 808 between the ½ flood risk zone 704 and the risk location 802.

To calculate primary risk values, an algorithm may execute an equation using the change in elevation 800 between a special flood hazard area and the address for which a risk is to be calculated. Such an equation may also use the change in elevation 804 between where the risk from a special flood hazard area is half that of the risk presented at the address. An analytic representation of such a calculation is shown in the formula:

$$\frac{Elevation difference at half {risk}^{2}}{( \begin{matrix}Elevation difference at half {risk}^{2} + \\ Elevation difference at full {risk}^{2}\end{matrix} )}$$

Where elevation at half risk refers to a location 704 at which the flood risk value from a special flood hazard area is one half that of the full flood risk value from that same special flood hazard area at the location 802 for which a risk is to be calculated. An additional component of the primary risk calculation is horizontal distance between a special flood hazard and the address for which a risk is to be calculated. As with the elevation difference calculation, the risk calculation uses both the difference between the full risk value 702 and the location 802 for which risk is to be calculated and the difference between the half risk value 704 and the location 802 for which a risk is to be calculated. An analytical representation of such a calculation is shown in the formula:

$$\frac{Distance difference at half {risk}^{2}}{( \begin{matrix}Distance difference at half {risk}^{2} + \\ Distance difference at full {risk}^{2}\end{matrix} )}$$

These elevation and distance components are combined using the formula:

Elevation calculation value*Distance calculation value*100

to produce primary risk factor.

Secondary Risk Value Calculations

Secondary risk calculations may comprise accumulation data for full and half risk values. Accumulation data may be derived from rainwater runoff accumulation analysis. In a manner similar to flood risk from bodies of water, runoff risk can be calculate using stormwater calculation tools such as the National Stormwater Calculator tool provided by the Environmental Protection Agency (“EPA”). Accumulation risk data may factor the surface area for which the risk data is being derived with the surrounding higher elevation areas that may drain into that surface area to arrive at a value for accumulation risk. Runoff data may be applied to geographic references to generate flood risk zones similar to those found in a FIRM. Distances between runoff accumulation risk zones and an entered address may be used to arrive at distance values from both the flood risk zone and also the point at which the risk is ½ that of the flood risk zone (half risk). The following formula is used to calculate accumulation risk:

$$\frac{( Accumulation Half {Risk}^{2} + {Accumulation}^{2} )}{Accumulation Half {Risk}^{2}}$$

If the above calculation produces a value that is greater than 100, a value of 100 may be substituted.

Referring to FIG. 9, secondary risk calculations may also comprise factors for levees 900 and dams 902. Levees 900 and dams 902 may present an additional flood risk should such a structure experience a failure. A dam 900 or levee 902 failure may allow a dramatic rise in water level for locations which may be in the path of water released in the case of such a failure. The flood risk 702 and ½ flood risk 704 zones as found in flood risk maps and databases may not represent the risk of flooding that may occur should levee 900 or dam 902 structures fail. Because of this, an analysis of flood risk associated with a body of water may be made more accurate by include factors that represent an analysis of secondary risks that result from possible dam or levee failures. If one or more levee 900 or dams 902 are present within a special flood hazard area associated with a flood risk for locations for which flood risk is to be calculated, a value of 50 may added to the secondary risk value calculation. This value is added to any accumulations risk value calculated above.

There may be additional secondary factors which are difficult or impossible to determine from flood risk maps or other geographic data. To account for these types of secondary factors, historical data concerning past flooding may also be used to calculate flood risk. Such historical data may indicate the presence of other sources of flood risk not easily detectable using geographic database information. In an exemplary embodiment of the present invention, if there is a record of prior flooding, a value of 50 is added to the secondary risk calculation. The values for accumulation risk, flood and dam risk, and historic flood risk are combined to produce a total secondary risk factor. Additional embodiments of the invention may allow historical risk factors to be further weighted as a result of multiple prior floods. Such further weighting may also be adjusted to account for the amount of time that has elapsed since such prior flooding. These further weighting factors may be implemented to improve the accuracy of a resulting risk score by taking into account multiple occurrences of past flooding or recent flooding that may be indicative of a developing trend.

Tertiary Risk Value Calculations

As described earlier, tertiary risk factors may be related to flood loss claims in the area containing the address for which flood risk is to be calculated. Tertiary risk values may comprise preferred risk policy repetitive losses where two such losses result in a value of 40 being added to the tertiary risk calculation value. Three or more preferred risk policy losses in the area result in a value of 80 being added to the tertiary risk calculation value. Tertiary risk factors may also comprise non-special flood hazard area claims in the area which the address for which flood risk is to be calculated is located. The number of claims in a ZIP+4 area, the standard deviation for the number of claims submitting in the state in which the ZIP+4 is located, and a scaling factor of 10 are combined using the following formula:

((standard deviation of claims²+number of claims in Zip plus 4²)/standard deviation of claims²)*scaling factor

The preferred risk policy loss factor may be combined with the non-special flood hazard area claims to produce a tertiary risk factor.

The above calculated primary, secondary, and tertiary risk factors are multiplied by exemplary weighting factors (respectively 1002, 1004, and 1006) and combined using the following formula to arrive at a combined risk score:

(Primary Risk Factor*0.5)+(Secondary Risk Factor*0.25)+(Tertiary Risk Factor*0.25)

The combined risk score may be used to calculate a risk factor for display on a risk factor map or provided as a numeric value as described earlier.

Additional Risk Factors

Additional factors that may be used to calculate flood risk include structural characteristics and direction of water flow. Structural characteristics may include such factors as building and foundation materials used, the type of foundation, and landscaping or other water control improvements made to a property. These factors may be obtained from real estate records or by prompting the parties interested in determining flood risk with questions designed to identify such factors. An exemplary embodiment of the present invention may place prompts in a user interface such as: “Please select the type of foundation used in the structure located at the address you have entered.” A response that a slab foundation exists may result in a lower risk than if the response was that a basement existed at the address entered.

Direction of water flow may also be considered when calculating flooding risk factors. Referring to FIG. 7, the direction of water flow 706, of a stream 700 is shown. A first structure 708 is illustrated with a lowest foundation point 710 which faces away from the direction of water flow 706. A second structure 712 is illustrated with a lowest foundation point 714 which faces toward the direction of water flow 706. Should the stream 700 overflow its banks to the point that water reach the lowest foundation points 710 & 714, one knowledgeable of types and extents of the damages caused by flooding will appreciate that water moving against a structure as would occur at the lowest foundation point 714, may cause more damage than would the same level of water moving away from a foundation point.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

What is claimed is:

1. A method of calculating flood risk for real property, comprising the steps of:
receiving the address of real property for which the flood risk is to be calculated;
determining the special flood hazard area value associated with the received address;
calculating additional factors to determine flood risk factors for the real property associated with the received address;
applying a weighing factor to the flood risk factors; and
combining the weighted factors to establish a risk score.

2. The method of claim 1, wherein said additional factors comprise:
the elevation difference between a special flood hazard area and the point for which the risk is being calculated;
the elevation difference between a point at which the flood hazard risk is ½ the special flood hazard risk and the point at which the risk is being calculated;
the distance between a special flood hazard area and the point for which the risk is being calculated; and
the distance between a point at which the flood hazard risk is ½ the special flood hazard risk and the point at which the risk is being calculated.

3. The method of claim 2, wherein said additional factors also comprise:
an accumulation risk; and
an accumulation 1/2 risk.

4. The method of claim 3, wherein said additional factors also comprise the existence of a water retention device within the special flood hazard area.

5. The method of claim 4, wherein said additional factors also comprise the occurrence or nonoccurrence of a past flood event at the received address of the real property.

6. The method of claim 5, wherein said additional factors also comprise the number of preferred risk policy flood losses in a geographic area.

7. The method of claim 6, wherein said geographic area is defined by the United States Postal Service ZIP plus 4 code associated with the received address of the real property.

8. The method of claim 6, wherein said additional factors also comprise the number of non-special flood hazard area claims in a geographic area and the standard deviation of such claims in the state in which the geographic area is located.

9. The method of claim 8 wherein said geographic area is defined by the United States Postal Service ZIP plus 4 code associated with the received address of the real property.

10. A computerized method of displaying flood risk comprising the steps of:
receiving an address for a property;
displaying in a user interface, a graphic representation of a map which includes said received address;
calculating at least one risk score for at least one of the areas displayed on said map; and
displaying at least one calculated risk score as a highlighted region on said map.

11. The method of claim 10, wherein calculating risk scores comprise:
factors related to an elevation difference between a special flood hazard area and the point for which the risk is being calculated;
factors related to an elevation difference between a point at which the flood hazard risk is ½ the special flood hazard risk and the point at which the risk is being calculated;
factors related to a distance between a special flood hazard area and the point for which the risk is being calculated; and
factors related to a distance between a point at which the flood hazard risk is ½ the special flood hazard risk and the point at which the risk is being calculated.

12. The method of claim 11, wherein calculating risk scores further comprises factors related to an accumulation risk and an accumulation ½ risk.

13. The method of claim 12, wherein calculating risk scores further comprises adding a predetermined value to the risk score in the event of the existence of a water retention device within the special flood hazard area.

14. The method of claim 13, wherein calculating risk scores further comprises adding a predetermined value to the risk score in the event of the existence of an occurrence of a past flood event at the received address of the real property.

15. The method of claim 14, wherein calculating risk scores further comprises adding a predetermined value to the risk score determined based upon the number of preferred risk policy flood losses in a geographic area.

16. The method of claim 15, wherein said geographic area is defined by the United States Postal Service ZIP plus 4 code associated with the geographic location at which the risk is being calculated.

17. The method of claim 15, wherein calculating risk scores further comprises adding an additional risk value calculated from the number of non-special flood hazard area claims in a geographic area and the standard deviation of such claims in the state in which the geographic area is located.

18. The method of claim 17 wherein said geographic area is defined by the United States Postal Service ZIP plus 4 code associated with the geographic location at which the risk is being calculated.

19. The method of claim 10, further comprising establishing an economic value for said property and computing a flood insurance premium based on said at least one risk score and said value.

20. A system for communicating the flood risk of a property to a user comprising:
a computer network;
a first computerized device for displaying flood risk information in electronic communication with a computer network;
a first database connected to said network, where said first database contains flood zone information arranged by geographic coordinates;
a second database connected to said network, where said second database contains terrain elevation data arranged by geographic coordinates;
a third database connected to said network, where said third database contains rainfall data arranged by geographic coordinates;
a fourth database connected to said network, where said fourth database contains a record of prior flooding arranged by geographic coordinates;
a fifth database connected to said network, where said fifth database contains a record of losses arranged by geographic coordinates; and
a second computerized device connected to said network which calculates flood risk information for geographic location using an algorithm to process database information contained in said databases.
